(19) United States
(12) Patent Application Publication
(10) Pub. No.: US 2006/0248732 A1
(43) Pub. Date: Nov. 9, 2006

(54) Spoon having a specially shaped bowl

(76) Inventor: Michael Straube, Ransbach-Baumbach (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/121,695

(22) Filed: May 4, 2005

(51) Int. Cl. A47J 43/28

(52) U.S. Cl. 30/324

(57) ABSTRACT

The invention relates to a spoon whose bowl is designed in order to enable the spoon to be used to effectively and efficiently empoty a cup containing, for example, food.

### BACKGROUND OF INVENTION

For the user the shapes of bowls of spoons known till now do not allow the effective and efficient emptying of a cup which contains e.g. dairy products.

With spoons of normal design due to the round shape always only one point of the side edge of the bowl will be in contact with the cup. With that always only a very small band of the content at the inner side of the cup can be removed. The consequence is that a complete emptying of the cup cannot occur, since the content is always squeezed around the point of contact of the spoon edge and is again spread at the inner side of the cup.

The known shapes of bowls do also not allow the effective and efficient emptying of the bottom and bottom edge of the cup. Because of the arch-shaped spoon tip here only a very small band of the content can be removed from the bottom, since the content is always squeezed around the point of contact of the spoon tip and is again spread at the bottom of the cup.

The bottom edge of the cup can only be reached through a rotation of the spoon. With the subsequent rotation of the spoon in the cup the content is mainly spread from the bottom edge to the wall of the cup.

### SUMMARY OF INVENTION

So in summary it is has to be stated that the quick emptying of a cup which e.g. contains dairy products is not possible with spoons having known forms of bowls. Thus always some residues of the food content will remain in the cups.

Thus it is the object of the present invention to provide a spoon whose bowl is designed in order to enable the spoon to be used to effectively and efficiently empty a cup containing, for example, food such as e.g. dairy products.

The object is met by a spoon as is described in the claims.

The bowl designed according to the present invention provides a quick problem-free manner for emptying cups in the field of food, wherein neither the motor activity nor other habits have to be changed. The plane side edge takes the food away from the sidewall without any problem. The plane side of the bowl opposite to the handle (lower edge of the spoon) takes the food without any problem and takes it easily from the bottom and the bottom edge. So a suitable uncomplicated emptying of the cup without any changes of the motions during eating will be achieved.

The consumer is happy, because of the feeling not to be forced to waste something any longer. The spoon having the novel form of the bowl designed according to the present invention provides a known feeling in the hand and provides for the user a known feeling in the mouth so that the use of the spoons according to the present invention does not require any adaptation of the habits. The complete emptying of a cup is possible in best time.

### BRIEF DESCRIPTION OF THE FIGURES

FIG. 1 shows the bowl in detail and defines the restriction sections (1), (2), (3) and (4) of the bowl according to the present invention.

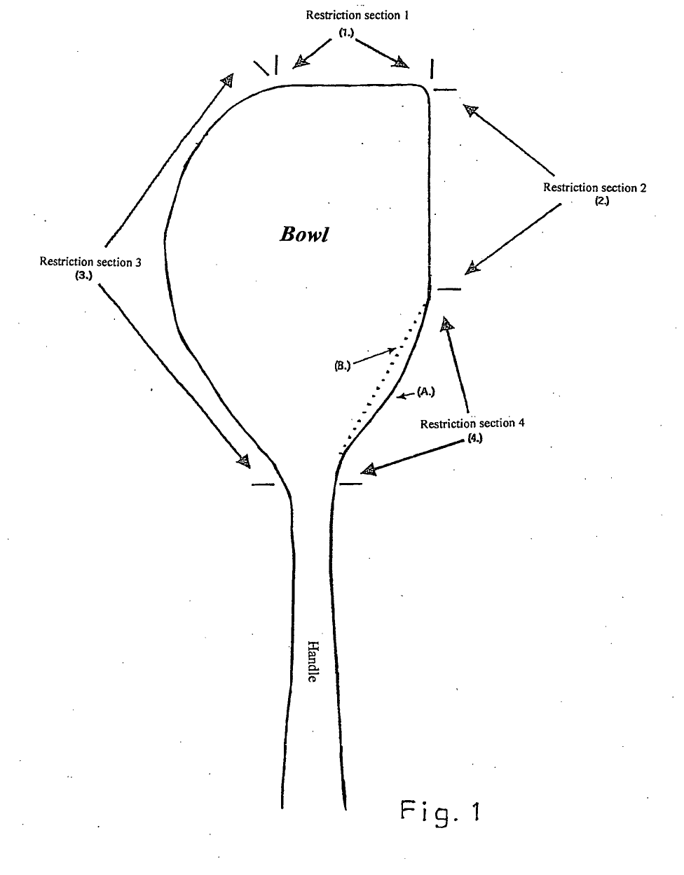

FIG. 2 shows a modified embodiment of the bowl according to the present invention.

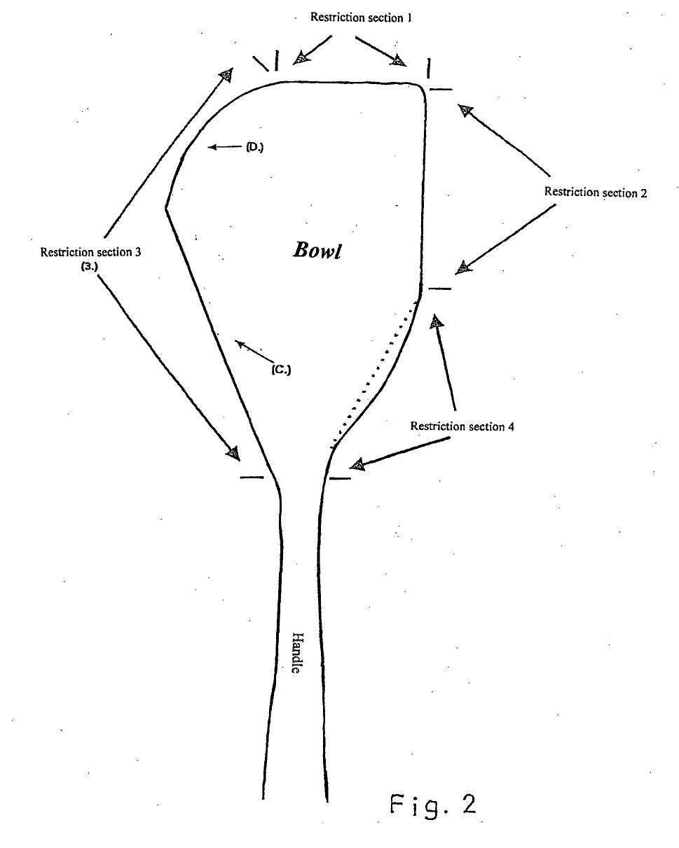

FIG. 3 shows the bowl of the present invention in a schematic way.

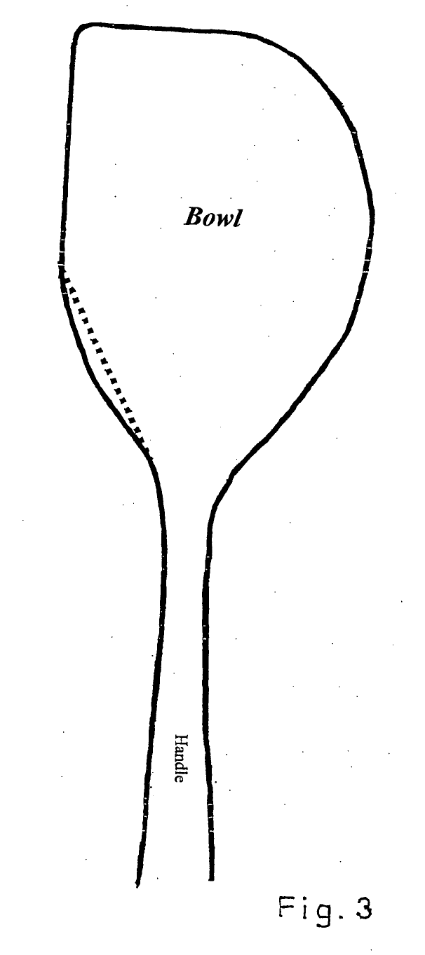

FIG. 4 shows that with the bowl designed according to the present invention with a familiar motion of the bowl in the cup the content can be removed simultaneously from the bottom edge and the lower sidewall. By the plane side opposite the handle the content can be removed from the bottom.

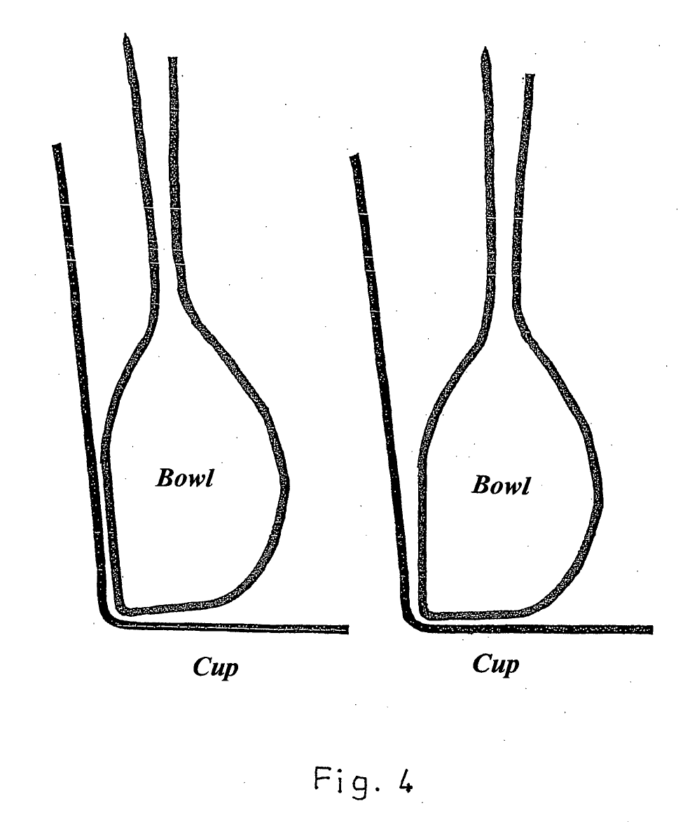

FIGS. 5 and 6 show in an exemplary way varying angles between the first restriction section and the second restriction section.

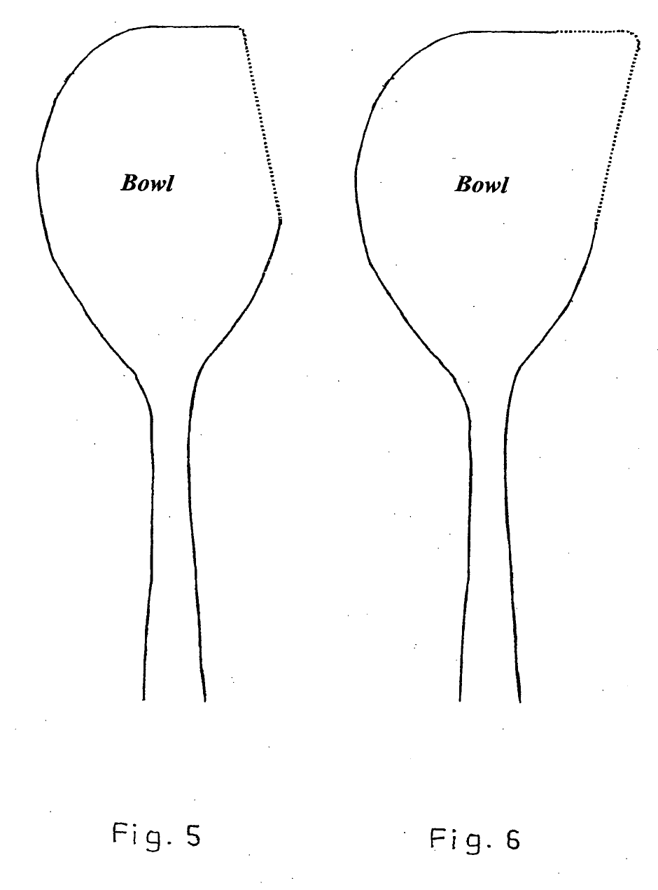

With suitable variations all angle ratios of the bottom to the sidewall of the vessels which are equipped with vertical sidewalls can be optimally covered.

What is claimed is:

1. A spoon consisting of a handle and a bowl, wherein the handle is designed at one end of the bowl, wherein the restriction of the bowl at the terminus of the bowl opposite to the handle has a plane first restriction section 1 to which a second restriction section 2 having a plane shape borders at the form of the bowl with a given angle ratio between 69° and 120°, wherein at the end of the first restriction section opposite to the second restriction section 2 a third arch-shaped restriction section 3 borders which extends to the base of the handle, wherein in the run of the form of the bowl at the second plane restriction section 2 an arch-shaped section or a plane section (fourth restriction section 4) borders which extend to the handle of the spoon.

2. The spoon having a form of a bowl according to claim 1, wherein the third restriction section 3 is divided into a plane and arch-shaped formed restriction section having an arbitrary angle ratio between them.

3. The spoon having a form of a bowl according to claim 1, wherein the position of the restriction sections 2 and 3 determine the form of the bowl in a mirror-inverted way (model for lefties).
